(19) United States
(12) Patent Application Publication
(10) Pub. No.: US 2004/0046704 A1
(43) Pub. Date: Mar. 11, 2004

(54) Computer system with multi-display device

(76) Inventor: Yong-Nam Kim, Seongnam-city (KR)

Correspondence Address: Blakely Sokoloft Taylor & Zafman, Seventh Floor, 12400 Wilshire Blvd, Los Angeles, CA, 90025-1026, US

(21) Appl. No.: 10/250,437

(22) PCT Filed: Dec. 20, 2001
(86) PCT No.: PCT/KR01/02223

(30) Foreign Application Priority Data
Dec. 29, 2000 (KR) 2000/86439

(51) Int. Cl. G09G 5/00

(52) U.S. Cl. 345/1.1

(57) ABSTRACT

Disclosed is a computer having one body integrated with multiple displays, and more particularly, a computer that has at least one display integrated or associated with one body to enable angle control, thereby providing the best angle of vision for users and especially for realizing multitasking and multimedia. The computer having one body integrated with multiple displays comprises a computer body including a main board, a CPU, a hard disk, a memory, a graphics processor or modem, and a display section that is integrally provided on one side of the computer body. The display section includes at least one display that is controllable in position.

### BACKGROUND OF THE INVENTION

(a) Field of the Invention

The present invention relates to a computer having one body integrated with multiple displays. More specifically, the present invention relates to a computer that has at least one display integrated or associated with one body to enable angle control, thereby providing the best angle of vision for users and especially for realizing multitasking and multimedia.

(b) Description of the Related Art

In general, a computer comprises a computer body including principal parts such as a main board, a central processing unit (CPU), a hard disk, a memory, a graphics processor or modem, and a monitor for visually providing display signals from the computer body to the user.

The body performs a variety of tasks, including Internet searching by the user's manipulation, realization of multimedia, and data creation using software of various kinds. The process and the output computed by the computer body are displayed on a monitor such as a liquid crystal display (LCD) to be visually provided to the user. The monitor is separately mounted on one side or on the topside of the computer body for the convenience of users.

But the conventional computer that has the computer body separated from the monitor is inefficient with respect to making good use of space or in providing an additional decorative effect. With the recent development and progress of computer programs and auxiliary equipment for the realization of multi-tasking and multimedia, there is a need for a system that supports realization of various multimedia and software multitasking to provide a wider visual interface between the computer and users.

### SUMMARY OF THE INVENTION

It is an object of the present invention to provide a computer having one body integrated with multiple displays that has at least one display integrated or associated with one computer body to enable angle control for the sake of a wider visual interface for users, thereby providing the best angle of vision for the users and for realizing multitasking and multimedia.

In one aspect of the present invention, there is provided a computer having one body integrated with multiple displays that comprises: a computer body including a main board, a central processing unit, a hard disk, a memory, a graphic processor and a modem; a plurality of display sections integrally provided on the computer body for displaying display signals on a screen; and a means for making axes perpendicular to the display sections meet in the front side of the display sections so as to provide an optimal field angle to users.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a perspective view of a computer according to a first embodiment of the present invention;

FIG. 2 is an elevational view of the computer shown in FIG. 1;

FIG. 3 is a side view of the computer according to the first embodiment of the present invention;

FIG. 4 is a plan view of the computer shown in FIG. 3;

FIG. 5 is an exploded view of an angle regulator according to the first embodiment of the present invention;

FIG. 6 is an assembled, cross-sectional view of the angle regulator shown in FIG. 5;

FIG. 7 is a perspective view of a display according to a second embodiment of the present invention;

FIG. 8 is a perspective view of a display according to a third embodiment of the present invention;

FIG. 9 is a perspective view of a display according to a fourth embodiment of the present invention;

FIG. 10 is a side view of the display shown in FIG. 9; and

FIG. 11 is a plan view of the display shown in FIG. 9.

### DETAILED DESCRIPTION OF THE PREFERRED EMBODIMENTS

In the following detailed description, only the preferred embodiments of the invention have been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

Hereinafter, a first embodiment of the present invention will be described in detail with reference to the accompanying drawings.

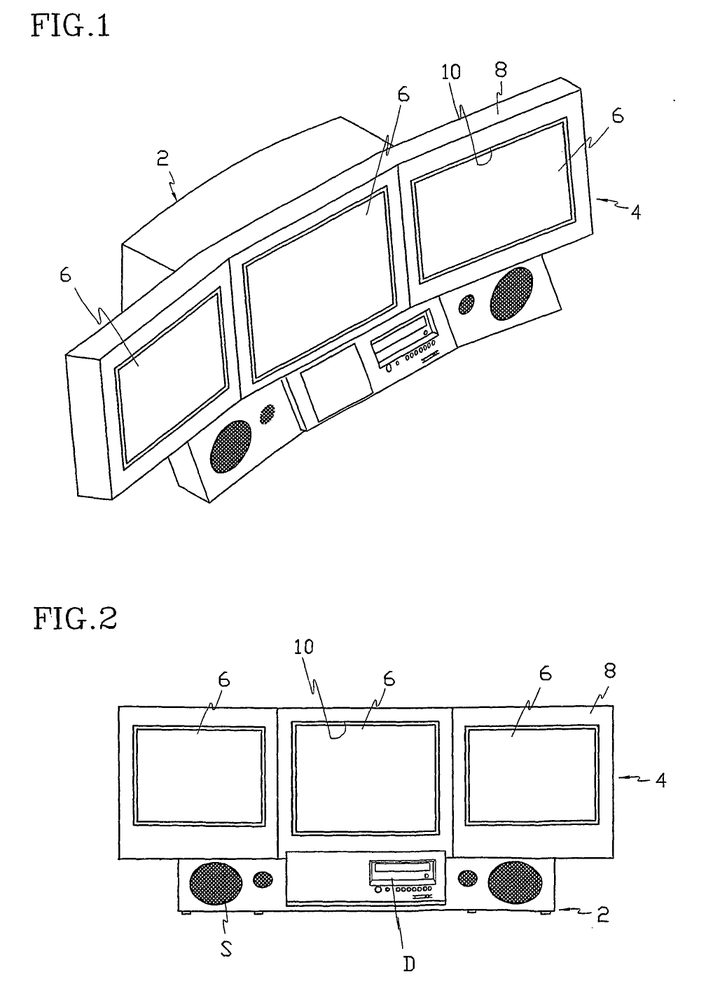

Referring to FIGS. 1, 2, and 3, a computer according to a first embodiment of the present invention comprises a computer body 2 including a main board, a CPU, a hard disk, a memory, a graphics processor or modem, a display section 4 integrally provided on one side of the computer body 2, and a means for defining the display angle of the display section 4.

The computer body 2, polygonal or circular in shape, is internally provided with known components for realizing multimedia and driving different software, and additionally a DVD ROM D and a speaker S are provided on its front side portion.

The display section 4 is integrally formed on one side of the computer body 2 and includes at least one display means 6.

In a case 8 integrally provided on the computer body 2 and used as a casing of the display means 6, an opening 10 is formed to define an outer frame of the display means 6. Preferably, the opening 10 is of such a size that allows different display angles of the display means 6.

The display means 6 may be a known plasma display panel (PDP) or a flat panel display device such as a thin film transistor-liquid crystal display (TFT-LCD) or an electro luminescent display (ELD), as long as it achieves the object of the present invention.

Compared to a CRT, a PDP, a TFT-LCD, and an ELD are more lightweight and less bulky by about 70 percent, and are therefore more accordant to the object of the present invention.

Although the above embodiment of the present invention employs a PDP, a TFT-LCD, or an ELC as the display means by way of example, any other display means may be used in the present invention as long as it achieves the object of the present invention.

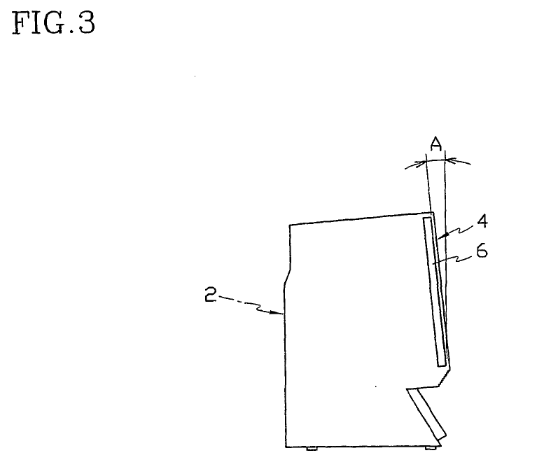

The display means 6 maintains a defined position in the case 8 on the one side of the computer body 2, and it has its upper front end slanted backward with a back inclination angle A with respect to its lower front end so as to provide an optimal angle of vision to the user (refer to FIG. 3).

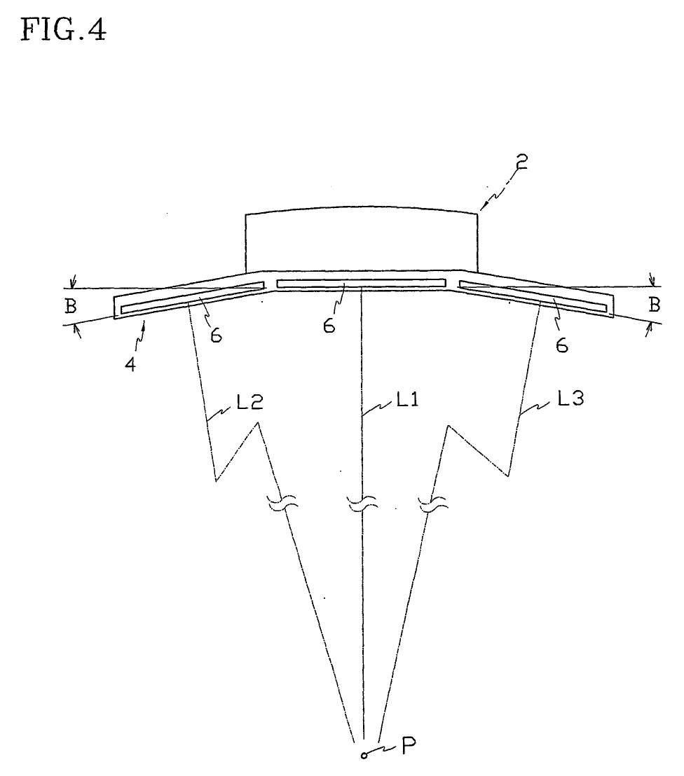

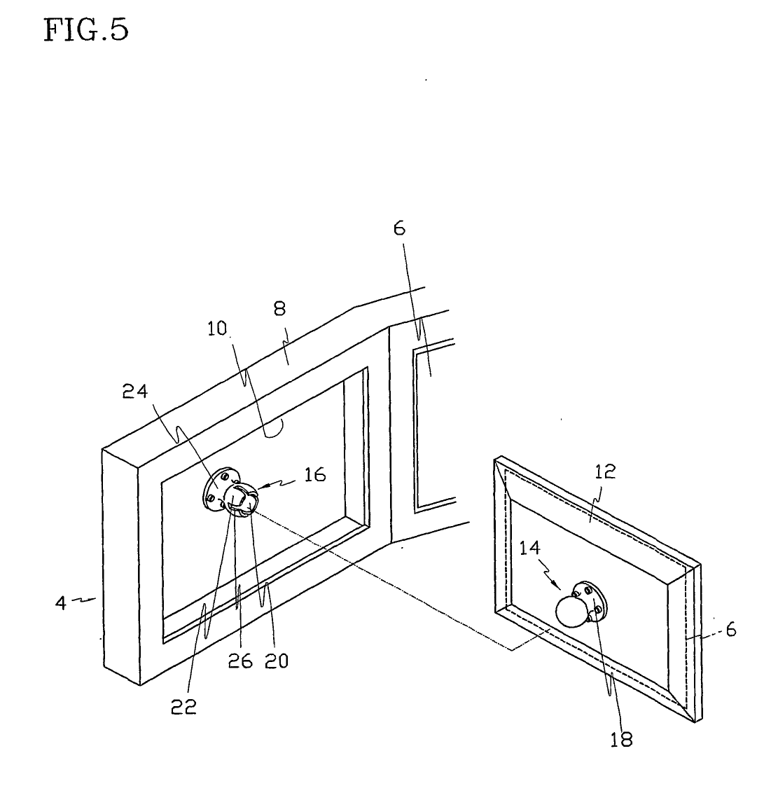

The display means 6 also slants inward with a lateral inclination angle B such that imaginary axial lines L1, L2, and L3 that are perpendicular to the display plane of the display means 6 meet at one point P (refer to FIG. 4).

The back inclination angle A and the lateral inclination angle B are in the range of at least 4 to 12 degrees so that the display plane of the display means 6 provides the best angle of vision to the user. In particular, the PDP, TFT-LCD, or ELD as used in the present invention have a defined field angle of about 15 to 30 degrees to minimize optical fatigue and to provide a clear image.

The display section 4 has an angle regulator to provide an optimal display according to the surroundings.

The angle regulator provides a means for regulating back inclination angle A and lateral inclination angle B.

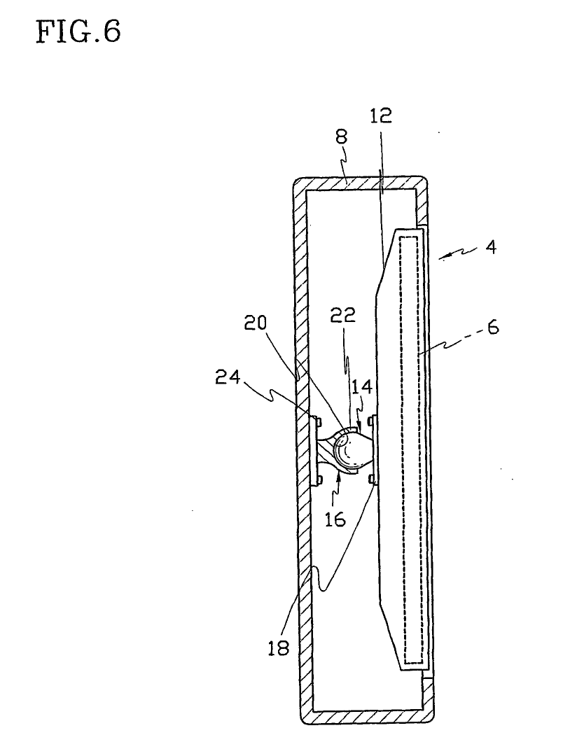

Referring to FIGS. 5 and 6, the angle regulator comprises a housing cover 12 disposed on the back surface of the display means 6, a ball member 14 disposed on one side of the center of the housing cover 12, and a pocket 16 disposed in the inner space of the case 8 to fix or slide the ball member 14 into.

In FIG. 5, all the signal electrodes connected to the display means 6 are omitted.

The housing cover 12, which is to protect the terminals and electrical wires (not shown) of the display means 6 that have a precise structure that is sensitive to temperature, is associated with the ball member 14. The housing cover 12 is made of a synthetic resin or a metal and is associated with the back surface of the display means 6.

The ball member 14 may be fixed directly to the display means 6 with an adhesive, and it may also be associated with the housing cover 12 by way of a circular or polygonal flange 18, or directly with the display means 6.

The pocket 16 comprises a holder 22 having a groove 20 that corresponds to the ball member 14, and a flange 24 integrally formed on one side of the holder 22 and associated with the inner side of the case 8.

Preferably, the holder 22 has at least one slot groove 26 in its outer circumference so that the ball member 14 is elastically supported and readily turned after association with the holder 22.

Though it has been described that the ball member 14 is associated with the housing cover 12 of the display means 6 and that the pocket 16 corresponding to the ball member 14 is associated with the inner side of the case 8, the ball member 14 may also be associated with the inner side of the case 8, with the pocket 16 being associated with the housing cover 12. In addition, any other structure and arrangement of the angle regulator may be employed in the present invention as long as it attains the object of the present invention.

Thus the display means 6 can be readily turned at any angle by way of the angle regulator to provide the best angle of vision to the user.

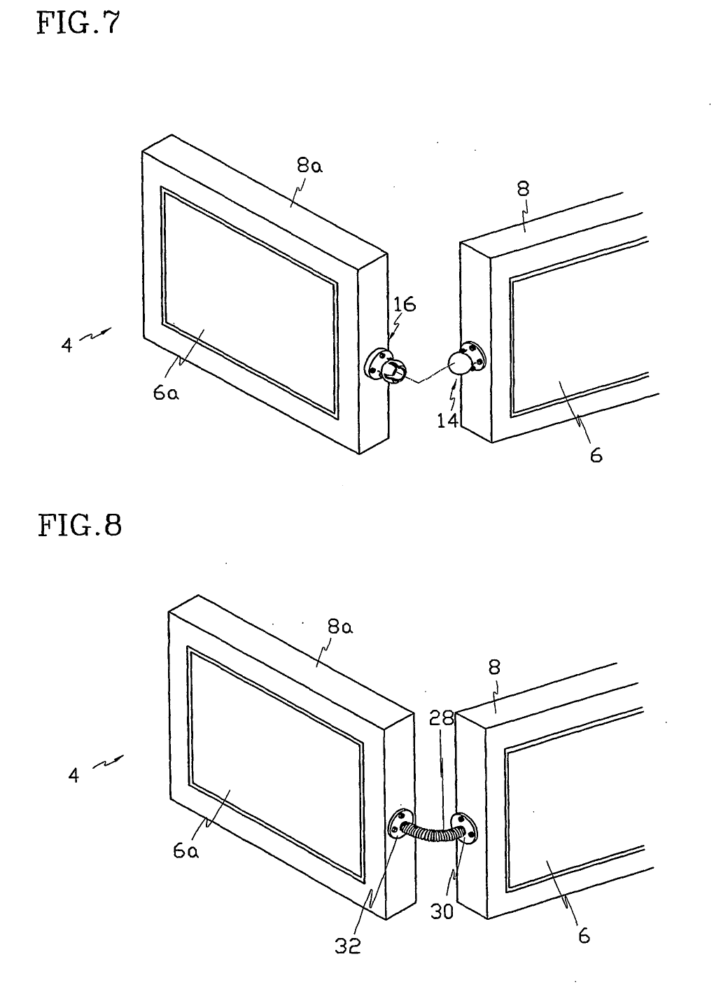

FIG. 7 shows a second embodiment of the display section 4 according to the present invention. In the first embodiment of the present invention, the display sections 4 with the display means 6 are fixedly integrated with the one side of the computer body 2. Contrarily, in the second embodiment of the present invention, at least one another display section 4 is separately provided on one side of the display section 4 or in the vicinity of either end of the display section 4, and it has a ball member 14 and a pocket 16 of the same structure as in the angle regulator of the first embodiment to regulate the angle of vision. The other features of this structure that are omitted in the description are the same as or similar to those in the first embodiment of the present invention.

As illustrated in FIG. 7, a second display means 6a associated with a second case 8a is provided on one side of the display means 6 that is integrally associated with the case 8 on the one side of the computer body 2. The ball member 14 is associated with the one side of the front end of the case 8 covering the display means 6, and the pocket 16 is associated with the one side of the front end of the case Ba covering the second display means 6a.

Thus the second display means 6a is closely associated with the display means 6 by way of the ball member 14 and the pocket 16, and it can be readily turned to form an angle that provides a wider field angle to the user.

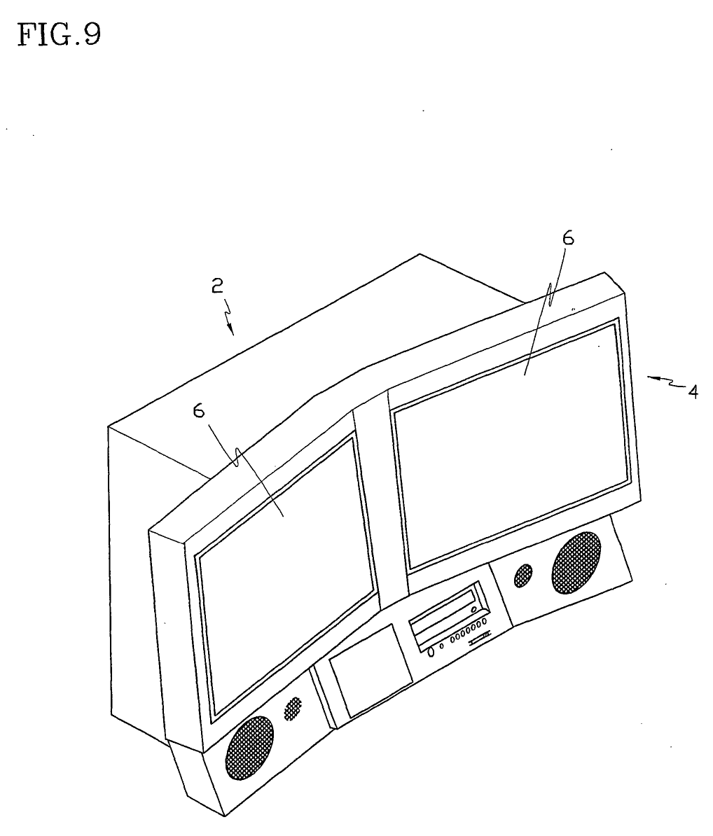

FIG. 8 shows a third embodiment of the present invention.

Compared with the second embodiment of the present invention in which the ball member 14 and the corresponding pocket 16 are associated with sides of the cases 8 and 8a, respectively, to change the angle between the display sections 4 for controlling the angle of vision therebetween, the third embodiment of the present invention uses a flexible tube 28 having a predetermined length and consisting of a metal or a synthetic resin so as to control the angle of vision. The other features of this structure that are omitted in the description are the same as or similar to those in the first embodiment of the present invention.

Flanges 30 and 32 are respectively provided on either end of the flexible tube 28, which is elastically transformed in shape by an external force and maintains the transformed shape after removal of the external force. The flange 30 on one end of the flexible tube 28 is associated with one side of the case 8 of the display means 6, and the flange 32 on the other end of the flexible tube 28 is associated with one side of the case 8a of the second display means 6a.

The second display means 6a, which is closely associated with the display means 6, can be turned by way of the flexible tube 28 to form an angle that is changeable with respect to the display means 6 to thereby provide a wider angle of vision to the user.

In addition to the angle regulating members employed in the second and third embodiments, i.e., ball joint and flexible tube, any other angle regulating member that attains the object of the present invention, such as a hinge member, may be used within the scope of the present invention.

FIG. 9 shows a fourth embodiment of the present invention. Compared with the first embodiment that has three display sections 4 and three display means 6 provided on the computer body 2, the fourth embodiment of the present invention has two displays and two display means on one body. The other features of this structure that are omitted in the description are the same as or similar to those in the first embodiment of the present invention.

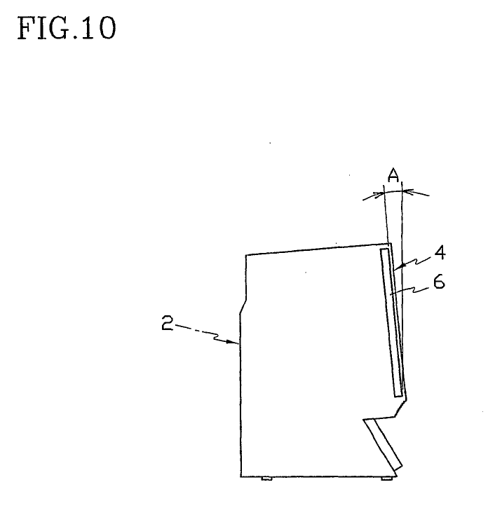

As illustrated in FIG. 9 in which two displays and two display means 6 are respectively provided on the one side of the computer body 2, the display means 6 maintains a defined position in the case 8 on one side of the computer body 2, and has its upper front end slanted backward with a back inclination angle A with respect to its lower front end to provide an optimal angle of vision to the user (refer to FIG. 10).

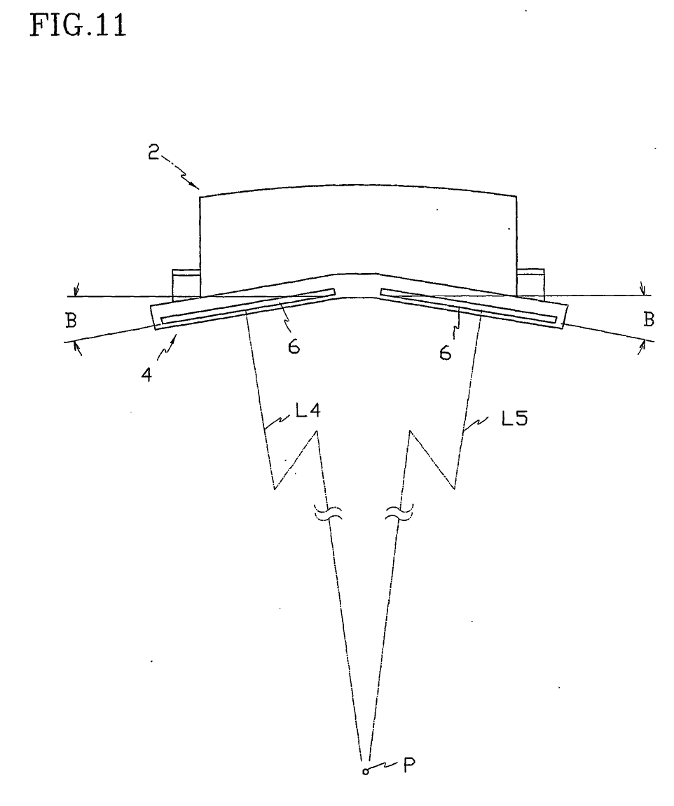

The display means 6 also slants inward with a lateral inclination angle B such that imaginary axial lines L4 and L5 that are perpendicular to the screen of the display means 6 meet at one point P, thereby providing the best angle of vision to the user (refer to FIG. 11).

In addition to the first and fourth embodiments, multiple display sections 4 may be integrally associated with the body to maintain a position that forms the back inclination angle A and the lateral inclination angle B and to provide the best angle of vision to the user.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A computer having one body integrated with multiple displays, the computer comprising:
a computer body including a main board, a central processing unit, a hard disk, a memory, a graphics processor, and a modem; and
a plurality of display sections integrally provided on the computer body and comprising a plurality of display means for displaying display signals received from the body.

2. The computer as claimed in claim 1, wherein each display section is integrally formed on one side of the computer body and is installed to have the upper front end of the display means slanted backward with a back inclination angle with respect to the lower front end of the display means so as to provide an optimal angle of vision to a user.

3. The computer as claimed in claim 1, wherein each display section has a lateral inclination angle such that imaginary axial lines that are perpendicular to a display plane meet at one point.

4. The computer as claimed in claim 1, wherein each display section has a display means, the display means independently having a position-changing means.

5. The computer as claimed in claim 4, wherein the position-changing means comprises:
a case;
a ball member provided on one side of the display means that is received in the case; and
a pocket having the ball member rotatably installed therein.

6. The computer as claimed in claim 1, wherein each display section is changeable in position with respect to its neighboring display sections.

7. The computer as claimed in claim 1, wherein each display means comprises any one of a plasma display panel (PDP), a thin film transistor-liquid crystal display (TFT-LCD), and an electro luminescent display (ELD).

8. The computer as claimed in claim 1 or 3, wherein the display sections maintain a lateral inclination angle of 4 to 12 degrees.

9. The computer as claimed in claim 1 or 2, wherein the display sections maintain a back inclination angle of 4 to 12 degrees.
